(19) United States
(12) Patent Application Publication
(10) Pub. No.: US 2006/0130038 A1
(43) Pub. Date: Jun. 15, 2006

(54) Apparatus, system, and method for facilitating dynamic modification of existing software objects defined in a strongly-typed programming language

(76) Inventors: Christopher Shane Claussen, Austin, TX (US); Pranta Das, Fremont, CA (US); Eric Nels Herness, Rochester, MN (US); Anh-Khoa Dinh Phan, Rochester, MN (US); Edwin V. Sapugay, San Bruno, CA (US)

Correspondence Address: KUNZLER & ASSOCIATES, 8 EAST BROADWAY, SUITE 600, SALT LAKE CITY, UT, 84111, US

(21) Appl. No.: 11/014,463

(22) Filed: Dec. 15, 2004

(51) Int. Cl. G06F 9/44

(52) U.S. Cl. 717/168

(57) ABSTRACT

An apparatus, system, and method are disclosed for facilitating dynamic modification of existing software objects defined in a strongly-typed programming language. The apparatus includes an invocation framework, an embedder, a reference component, and a development reference component. The invocation framework is configured to pass a loosely-typed base object between a source component and a destination component. The embedder embeds a business object within the base object. The business object is defined at least in part by a type definition having a set of attributes and a name value uniquely associating the type definition to the business object. The reference component references the base object such that typing requirements of the business object are not explicitly enforced in a runtime environment. The development reference component references the type definition within a development environment such that typing for the business object is fixed during source code development and deployment.

### BACKGROUND OF THE INVENTION

1. Field of the Invention

This invention relates to software development and more particularly relates to facilitating modification of software objects defined in a strongly-typed programming language.

2. Description of the Related Art

Software development and software architectures continue to advance from a component/module tiered architecture to a service-based architecture. In a service-based architecture, a source component interacts with destination component by passing information according to a predefined interface between the components. As used herein, the term “interface” refers to a specification that exists between software components that specifies a selected means of interaction that includes functions, methods, parameters, and parameter signatures including parameter data types. The components may communicate using the interface either directly or indirectly by way of a broker such as a Websphere Business Integration (WBI) available from IBM of Armonk, N.Y.

Generally, the interfaces specify one or more objects that can be passed between components using open transport and service exchange protocols such as Web Services Description Language (WSDL) which uses other common technologies such as eXtensible Markup Language (XML), XML Schema Definitions (XSD), Simple Object Access Protocol (SOAP), Hypertext Transfer Protocol (HTTP), and the like. These technologies enable developers to define the structure and type information for objects passed in the interface. The developers can quickly change an interface by modifying the information in an XSD for example.

Typically, automated tools reference the WSDL and associated XSD information to generate source code defining objects in the programming language the developer uses to write the source/destination component. This is problematic however where the developer uses a strongly-type programming language such as JAVA or C++ to develop the component that interacts with the interface. Consequently, the interface is now strongly typed because the component is strongly typed and expects to receive strongly-typed objects that conform to the services interface defined in the WSDL.

The use of strongly-typed objects (manually or automatically generated) on either end of the interface provides advantages to a developer within the development environment. First, the source code objects can be referred to from within an Integrated Development Environment (IDE) to assist a developer in writing source code. For example, code-complete technologies can refer to the source code objects and automatically provide the developer with a pick list of attributes that can be accessed in an object passed through the interface.

Second, when source code is compiled, a compiler can refer to the strongly-typed objects to catch and flag type errors in a developer's source code. For example, a developer could pass a data value having a string data type to a function that only accepts data values having an integer data type. The compiler can greatly assist the developer by identifying type related errors before the component is executed in a runtime environment.

However, strongly typed interfaces are very problematic in a runtime environment. Because a strongly-typed programming language is used to implement the interface, a typing dependency is created between the interface implementation (the executable software code or strongly-typed objects) and the interface definition (the WSDL and XSD information). This dependency is reflected in the method signatures of the strongly-typed objects as well as in substantially all other source code references to the strongly-typed objects.

The typing dependency is centered on the strongly-typed objects. In other words, the typing dependency is at the object level and not solely at the object attribute level. Changes, made dynamically during runtime or during development time, to the structure (methods and/or attributes) and/or attribute data types of a strongly-typed object passed between a first component and second component requires a similar code change in both components. In addition, this code change may have a ripple effect as all other references in the components to the strongly-typed object must also be changed.

Such a ripple effect code change can be very disruptive in an Enterprise Information System (EIS). The change may affect not only the two components that communicate using the strongly-typed objects but middleware software such as a broker that manages inter-application communication.

Generally, the code change requires that components of one or more of the components referencing the strongly-typed objects be stopped and restarted. This disruption severely impacts an application's quality of service and continuous availability objectives. In addition, in a business-to-business enterprise system, changes to strongly-typed objects by one business can require changes in an unrelated or unknown business because the typing aspect of the interface has changed.

From the foregoing discussion, it should be apparent that a need exists for an apparatus, system, and method for facilitating modification of software objects defined in a strongly-typed programming language. Beneficially, such an apparatus, system, and method would separate typing information for strongly-typed objects of an inter-component interface from the interface itself. The apparatus, system, and method would also provide access to the typing information for static type checking and code assist operations in the development environment.

### SUMMARY OF THE INVENTION

The present invention has been developed in response to the present state of the art, and in particular, in response to the problems and needs in the art that have not yet been fully solved by currently available software architectures. Accordingly, the present invention has been developed to provide an apparatus, system, and method for facilitating modification of software objects defined in a strongly-typed programming language that overcome many or all of the above-discussed shortcomings in the art.

The apparatus for facilitating modification of software objects defined in a strongly-typed programming language is provided with a logic unit containing a plurality of components configured to functionally execute the necessary steps. These components in the described embodiments include an invocation framework, an embedder, and a reference.

The invocation framework passes a loosely-typed base object between a source component and a destination component. Preferably, a portion of the invocation framework resides on both the source component and the destination component. The embedder embeds a business object within the base object, the business object defined at least in part by an uncompiled type definition comprising a name value and a set of attributes. The name value serving as a unique identifier associating the type definition to the business object. The type definition may optionally define a data type for at least one attribute of the business object. The reference component references the base object in a runtime environment to verify typing requirements between the source component and the destination component such that typing requirements are not explicitly enforced for the business object. The base object is referenced in communicating between the source component and the destination component instead of the business object.

In one embodiment, the apparatus includes a development reference component that references the type definition within a development environment such that typing for the business object is fixed during source code development and deployment. In another embodiment, the type definition defines an attribute structure for the business object. The apparatus may further comprise a modification component configured to modify the type definition such that the attribute structure of the business object changes without affecting parameter typing requirements in force between the source component and the destination component.

A validator of the apparatus may load a business object identified by the name value within the development environment in response to declaration of a new base object and in response to compilation of source code comprising a new base object. The validator may validate type information for data values referenced in the source code against the type definition corresponding to the name value and signal an error in response to a type mismatch. The base object may be referred to as a fixed-type object because the base object fixes the type within the development environment and not within the runtime environment. The apparatus may comprise a mediator configured to convert fixed-type objects to strongly-typed objects and strongly-typed objects to fixed-type objects as needed.

The apparatus may also include a packager configured to deploy executable code for the base object to an object definition repository accessible to both the source component and the destination component such that declarations to generate the base object in the source component and the destination component references the same base object executable code. An editor may be provided that defines a loosely-typed parameter passing interface between the source component and the destination component that passes the base object in place of business objects. The methods and attributes of the business objects may be accessible to the source component and destination component by indirect software calls that reference the base object and the value of a desired business object.

A system is also presented for facilitating modification of software objects defined in a strongly-typed programming language. The system includes components substantially similar to those described above in relation to different embodiments of the apparatus. In addition, the system includes an application server configured to execute a source application and a destination application. The source application may correspond to the source component and the destination application may correspond to the destination component described above.

A method is also presented for facilitating modification of software objects defined in a strongly-typed programming language. The method in the disclosed embodiments substantially includes the steps necessary to carry out the functions presented above with respect to the operation of the described apparatus and system.

In one embodiment, the method includes an operation to pass a loosely-typed base object between a source component and a destination component, an operation to embed a business object in the base object, the business object defined at least in part by a type definition comprising type information for attributes of the business object, the type definition comprising a name value and a set of attributes, the name value serving as a unique identifier associating the type definition to the business object, and each attribute having a data type, and an operation to reference the base object within a runtime environment such that the type information for the business object is not explicitly enforced within the runtime environment.

As used herein, the term “component” can refer either to a functional set of software such as an application, an object, a method, or the like or to a functional unit described in this specification labeled as a component. Those of skill in the art will recognize the difference from the context. The term “type” refers both to a data type as understood by those of skill in the art as well as to a type of argument or parameter including an object type. Object types may be distinguished from each other in languages that employ type checking by different names, structures, internal data types, and the like.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for facilitating modification of software objects defined in a strongly-typed programming language;

FIG. 2 is a schematic block diagram illustrating another embodiment of an apparatus for facilitating modification of software objects defined in a strongly-typed programming language;

FIG. 3 is a schematic block diagram illustrating an alternative system for facilitating modification of software objects defined in a strongly-typed programming language;

FIG. 4 is a schematic block diagram illustrating one embodiment of base object configured to for use in accordance with the present system, apparatus, and method;

FIG. 5 is a schematic flow chart diagram illustrating one embodiment of a method for facilitating modification of software objects defined in a strongly-typed programming language in a runtime environment; and

FIG. 6 is a schematic flow chart diagram illustrating one embodiment of a method for facilitating modification of software objects defined in a strongly-typed programming language in a development environment.

### DETAILED DESCRIPTION OF THE INVENTION

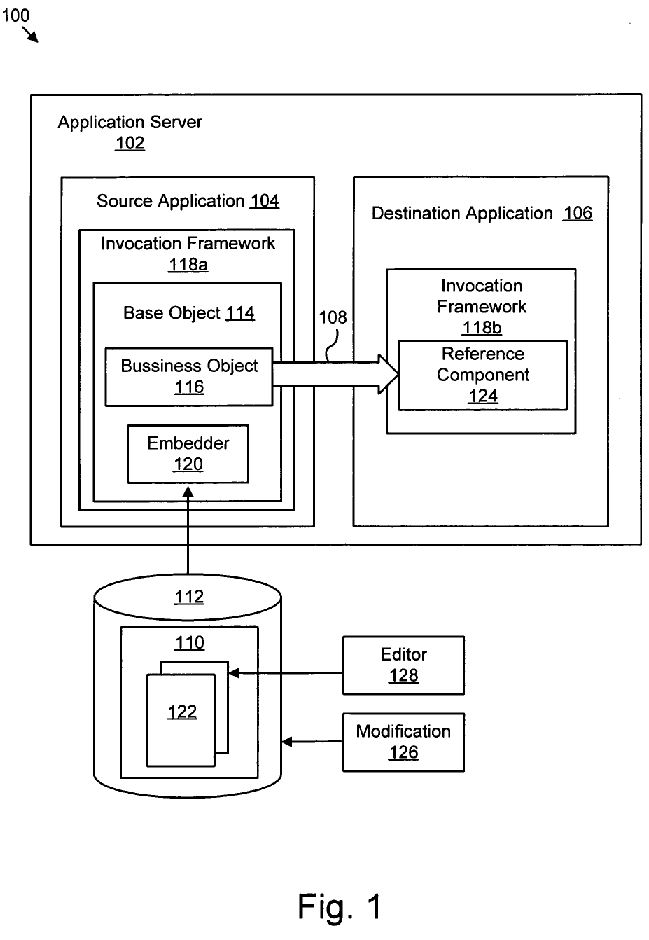

FIG. 1 illustrates a system 100 for facilitating modification of software objects defined in a strongly-typed programming language. The system 100 includes an application server 102 executing a source application 104 and a destination application 106. The application server 102 may comprise a Java Version 2 Enterprise Edition (J2EE) server. The application server 102 may comprise a Websphere Application Server (WAS) available from IBM. The source application 104 and destination application 106 may comprise J2EE applications. Of course, the source application 104 and destination application 106 may execute on different application servers. The source application 104 and destination application 106 are configured to communicate with each other using a service based interface 108 such as web services.

Specifically, the interface 108 may be defined using a loosely-type parameter passing interface 108. Preferably, the interface 108 is defined using a common, open, protocol such as a WSDL structure 110. A WSDL structure 110 may comprise a file, dataset, record, or other well known data structures. The WSDL structure 110 may be stored on a repository 112 accessible to both the source application 104 and the destination application 106. Alternatively, the source application 104 may send the WSDL structure 110 to the destination application 106 when communication is first established.

In one embodiment, the interface 108 designates at least one loosely-typed base object 114 to be passed between the source application 104 and the destination application 106. A loosely-typed base object 114 is a generic object that serves as a carrier for one or more application-specific objects. The application-specific objects are known as business objects 116 because they typically reflect the data parameters and/or operation parameters exchanged between two business logic units (for example Enterprise Java Beans (EJBs)) of applications.

The loosely-typed base object 114 carries the business object 116 to the destination application 106. The business object 116 is typically defined in source code of a strongly-typed programming language. Consequently, if the business object 116 is communicated there is a typing dependency on each end of the interface 108, as described above. In contrast, the system 100 exchanges the loosely-typed base object 114 such that each end of the interface has a loose type dependency requiring just that the object passed be of object type base object 114. Advantageously, the business objects 116 can change without affecting the interface 108.

The system 100 includes an invocation framework 118. Preferably, the invocation framework 118 comprises a pair of collaborating portions 118a-b that reside on both the source application 104 and the destination application 106. The invocation frameworks 118a-b are configured to exchange the loosely-typed base object 114. In one embodiment, the invocation frameworks 118a-b may comprise J2EE web services code libraries or objects configured to interpret WSDL messages and make the proper calls to objects on either the source application 104 or the destination application 106.

Consequently, providing a WSDL structure 110 to the applications 104, 106 that defines messages for passing a loosely-typed base object 114, the applications 104, 106 may automatically implement the invocation frameworks 118a-b. The WSDL structure 110 causes the invocation frameworks 118a-b to pass the base object 114 in place of the business objects 116. As explained in more detail below, the methods and attributes of the business objects 116 are accessible to code in the applications 104, 106 using indirect software calls referencing the base object 114 and the name of the business object 116 desired.

In one embodiment, the WSDL structure 110 defining the interface 108 may include a port type. Operations for the port type may be defined by messages defined in XSDs associated with the WSDL. Operations may include one-way operations, request-response operations, solicit-response operations, and notification operations. Those of skill in the art will recognize that invocation frameworks 118a-b may be implemented with minimal modifications to existing WSDL structures 110 because the J2EE applications 104, 106 may already include core invocation frameworks 118a-b.

Preferably, the source application 104 creates a base object 114 (also referred to as an instance of a base object 114), unless one already exists. The base object 114 may include an embedder 120 that is preferably activated when the base object 114 is created. Alternatively, the embedder 120 is within the source application 104.

The embedder 120 embeds the business object 116 within the base object 114. In one embodiment, the embedder 120 reads an uncompiled type definition 122 that defines at least a portion of the business object 116. In certain embodiments, the type definition 122 completely defines the methods and attributes for the business object 116.

The type definition 122 may be defined in an uncompiled format such as text and stored in the repository 112. The repository 112 may comprise a file system, data store, database, or the like. In one embodiment, the type definition 122 comprises XSDs defined for a WSDL structure 110.

The type definition 122 may include a name value and a set of attributes. The set of attributes may be organized into an attribute structure for a business object 116. The attributes define the object attributes for the business object 116 and the data type for each attribute. The name value serves as a unique identifier that associates the business object 116 to the type definition 122.

For example, suppose a business object 116 prior to using the system 100 as defined by a java class named customer.class with attributes name of type string and customer id of type integer. Within the system, no “customer.class” file would exist. Instead, a type definition 122 implemented using an XSD entry in a WSDL structure 110 includes a name value (“customer”) and a set of attribute name—attribute type pairs, i.e., (name, string; customer_id, 2). Similarly, other business objects 116 for a client, a contact, an employee, and the like may include separate type definitions 122.

The source code that instantiates the base object 114 preferably includes the name value such that the embedder can generate a business object 116 as an attribute of the base object 114. The invocation framework 118a sends the base object 114 to the destination application 106 according to the interface 108. The destination application 106 preferably includes a reference component 124.

The reference component 124 references the base object 114 received within the runtime environment (defined and managed by the application server 102) and verifies the typing requirements defined by the interface 108. Preferably, the typing requirements are defined by the base object 114. In other words, the reference component 124 ensures that the message received from the source application 104 is an object having a type matching the object type of a base object 114. The reference component 124 does not, however, check typing of the business object 116. Instead, the reference component 124 checks typing at the object level in relation to the interface 108. Consequently, the type of business object 116 can change without violating typing requirements defined by the interface 108.

In certain embodiments, the reference component 124 and invocation frameworks 118a-b are components provided as part of a web services library provided by the application 104, 106. Alternatively, the reference component 124 and invocation frameworks 118a-b may be independently developed. The base object 114 encapsulates the business objects 116 such that the interface 108 becomes loosely typed rather than strongly-typed.

The loosely-typed base object 114 has an inherent type because the loosely-typed base object 114 has a structure and the methods and attributes of the loosely-typed base object 114 have data types. However, the loosely-typed base object 114 is loosely-typed because the same generic object type, base object 114, is used regardless of the object types the source application 104 or destination application 106 are written to exchange. The source application 104 and destination application 106 are configured to access the business object 116 through the base object 114.

The system 100 may also include a modification component 126 and an editor 128 both of which may be used separate from the runtime environment (which is controlled and managed by the application server 102). The modification component 126 modifies a type definition 122 to change the structure (methods and/or attributes) and/or data type information of a business object 116. Advantageously, as explained above, modifications to the business object 116, as defined in the type definition 122, do not affect the parameter typing requirements defined by the interface 108 between the source application 104 and the destination application 106.

In certain embodiments, the modification component 126 may modify type definitions while the applications 104, 106 continue executing. The next time a base object 114 for a modified type definition 122 is generated the modified type definition 122 will be used. In this manner, business objects 116 can be dynamically modified without shutting down or restarting the applications 104, 106. Consequently, the dynamicity of the applications 104, 106 is greatly enhanced. The WSDL structure 110 and type definitions 122 may be deployed in a declarative format, meaning non-compiled. Consequently, the type definitions 122 can be readily changed without recompiling or restarting portions of the applications 104, 106. In addition, the dynamic modification of the business object 116 does not affect the interface 108 as they do in conventional systems.

The editor 128 defines the type definitions 122 and/or WSDL structure 110. The editor 128 may include a graphical user interface and various tools to assist a developer or administrator in defining the type definitions 122. In certain embodiments, the editor 128 and modification component 126 may be integrated into a single component.

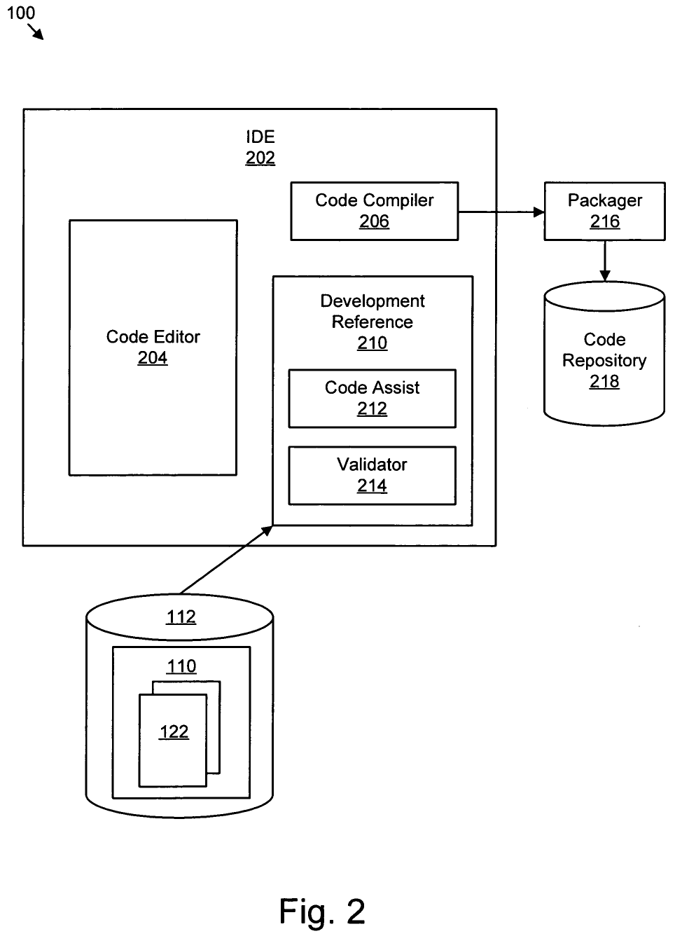

Preferably, embodiments of a system, method, or apparatus for facilitating modification of software objects defined in a strongly-typed programming language may be implemented and used in both the runtime environment such as a J2EE application server 102 and a development environment illustrated in FIG. 2. Referring now to FIG. 2, one or more components of the system 100 used in the runtime environment may also be used as part of an Integrated Development Environment (IDE) 202. In one embodiment, the IDE 202 comprises an apparatus in accordance with the present invention that may form part of the system 100 described in relation FIG. 1.

The IDE 202 may include a source code editor 204, a source code compiler 206, a debugger 208, and a development reference component 210. Preferably, the code editor 204, code compiler 206, and debugger 208 comprise similar well known conventional components that are modified to invoke the development reference component 210 when a loosely-typed base object 114 (See FIG. 1) is encountered in the IDE 202. Preferably, when a base object 114 is encountered, the development reference component 210 references the type definitions 122 such that typing for business objects 116 is fixed within the IDE 202.

In one embodiment, the code editor 204 may be configured to dynamically call the development reference component 210 in response to a developer typing in a name identifying a base object 114. For example, a developer may declare a new base object within the code editor 204. An example call may be: “Myobj=new base_object (.” Once the term “base_object,” or its implementation equivalent, is typed, the code editor 204 may automatically call the development reference component 210 with the term “base object”.

The development reference component 210 may include a code assist component 212 and a business object validator 214. The code assist component 212 may respond to the call from the code editor 204. A code assist component 212 provides source code portions, parameter list information, parameter typing information, and the like to a developer as the developer edits source code in the code editor 204. Those of skill in the art will recognize the benefits of code assist components 212. In one embodiment, the code assist component 212 extends an existing code assist component to add support for referencing base objects 114 and business objects 116 that may be embedded therein.

In particular, the code assist component 212 may reference the type definitions 122 in one or more WSDL structures 110 in a repository 112 to assemble a list of name values for business objects 116 that a developer may desire to use as an argument to the base object 114. The code assist component 212 or the code editor 204 may present the list of name values to the developer. The developer may select a name from the list of a business object 116 defined in the repository 112. In this manner, a properly spelled and valid name value for an existing business object 116 is inserted into the source code.

In addition, as a developer enters method names for the base object 114, the code assist component 212 may dynamically present pick lists, or drop-down lists, of valid methods and/or attributes of the selected business object 116. For example, suppose a customer business object 116, having name value “Customer,” is defined in the type definitions 122. The developer may enter: “base_object.SetAttribute(“Customer.”” Then, the code assist component 212 may signal the business object validator 214 to load the business object 116 identified by the name value, “Customer,” from the repository 112. The business object validator 214 and/or code assist component 212 may then cooperate with the code editor 204 to present a list of attributes defined for the customer business object 116, such as name, addresss1, addresss2, etc. The developer may select “Name” such that the source code line reads: “base_object.SetAttribute(“Customer,” “name,” “Joe”);”

In certain embodiments, in addition to loading business objects 116, the business object validator 214 may validate type information for data values referenced in the source code against a type definition 122 defined for the business object 116. For example, in the source code line: “base_object.SetAttribute(“Customer,” “name,” “Joe”);” once the ‘;’ is entered the validator may check to ensure that the data type expected for the attribute “name” which is string corresponds to the data type of the data value “Joe.” If there is a data type mismatch, the business object validator 214 may signal a type error for the business object customer 116.

The business object validator 214 may validate business object 116 data types dynamically or in response to a call from the compiler 206. In certain embodiments, when the compiler 206 reaches a line of source code that refers to a base object 114, the compiler 206 may send the line to the business object validator 214 for validation. If the methods, attributes, and data type information of the source code line satisfy the requirements set out in the business object 116, the compiler 206 continues compiling the next line of source code. If not, the compiler 206 may signal an error. The error message may be provided by the business object validator 214.

The development reference component 210 provides type enforcement for business objects 116 in a development environment, IDE 202, and for source code deployment operations such as compiling. Preferably, the development reference component 210 integrates with the IDE 202 to provide code-assist features with respect to business objects 116 and type checking of business object 116 at compile time. Together the system 100 and the development reference component 210 provide for an interface that passes business objects 116 within loosely-typed base objects 114 in the runtime environment and provides the benefits of type checking (code assist and compile time checking) for business objects 116 in the development environment. Because typing for business objects 116 is fixed within the type definitions 122, enforced in the development environment, and loose within the runtime environment, the business objects 116 are said to be fixed-type objects 116.

To function within the runtime environment, the compiled executable code for the base object 114 must be accessible to both the source application 104 or component 104 and the destination application 106 or component 106. Consequently, in certain embodiments, the IDE 202 interacts with a packager 216 that deploys executable code for the base object 114 to an object definition repository 218. The object definition repository 218 is accessible to both the source application 104 and the destination application 106 during runtime. Preferably, just one version of the executable code for the base object 114 is available to the applications 104, 106. In this manner, the source application 104 and the destination application 106 both use the same base object executable code for the interface 108. In other words, a declaration to generate the base object 114 in either application 104, 106 will reference the same base object executable code.

In one implementation, the application server 102 is a J2EE application server and the applications 104, 106 each have independent class loaders. Consequently, the packager 216 places the base object executable code in a location accessible to the class loader for the application server 102. In addition, the object definition repository 218 may comprise a file system and the base object executable code may be a class file. Alternatively, the object definition repository 218 may comprise a database, data store, or the like.

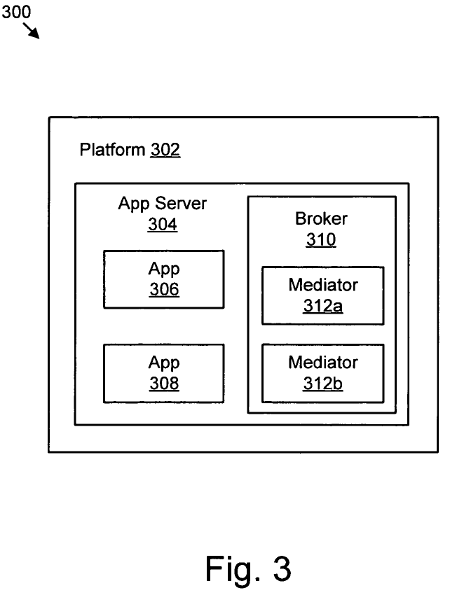

FIG. 3 illustrates an alternative system 300 for facilitating dynamic modification of existing software objects defined in a strongly-typed programming language. The system 300 may comprise a platform 302 such as a Java platform such as Java Version 2 Standard Edition (J2SE) or J2EE. The platform 302 provides a common operating environment that is substantially hardware and operating system independent. One or more application servers 304 operate within the platform 302. The application server 304 may comprise a Websphere Application Server (WAS). Two or more applications 306, 308 operate within the application server 304.

The system 300 includes a broker 310 configured for facilitating dynamic modification of existing software objects defined in a strongly-typed programming language. The broker 310 may comprise one embodiment of an invocation framework 118a-b described in relation to FIG. 1. Among other services, the broker 310 serves as an intermediary for communication of messages, data, objects, and the like between the applications 306, 308.

The broker 310 includes at least one mediator 312. A mediator 312 converts a fixed-type object such as a base object 114 (See FIG. 1) to a strongly-typed object. In addition, a mediator 312 may convert a strongly-typed object to a fixed-type object such as a base object 114. A fixed-type object is an object for which the definition of the object structure, its methods or attributes and associated typing information “fixed” within a type definition 122. The typing information is fixed for developers using the development environment 202 and relaxed through use of the loosely-typed base object 114 in the runtime environment. A strongly-typed object that conforms to the typing requirements of a source application 306, a destination application 308, or both.

In one embodiment, a first mediator 312a performs conversion between a fixed-type object and a strongly-typed object and a second mediator 312b performs conversion between a strongly-typed object and a fixed-type object. Consequently, the broker 310 may direct objects received from a source application 306 through the first mediator 312a and second mediator 312b one or more times until the resulting object is of the type expected by the destination application 308.

Of course, the broker 310 may perform other processing on an object. Consequently, the broker 310 may use the mediators 312a-b in suitable manner to convert a received strongly-typed object to a fixed-type object and then back to a strongly-typed object. In one embodiment, the broker 310 detects a type mismatch between the type of object received (strongly-typed versus fixed-type) and automatically converts the object to a fixed-type object or a strongly-typed object depending on the type of object expected by the destination application 308.

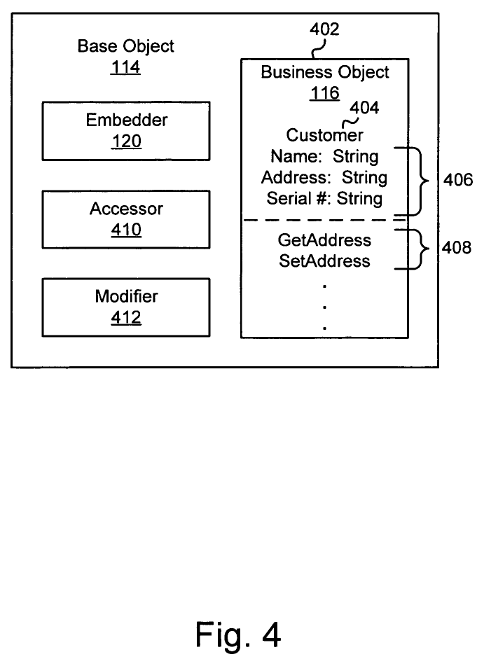

FIG. 4 illustrates one embodiment of a base object 114 suitable for use with a system, method, and apparatus for facilitating dynamic modification of existing software objects defined in a strongly-typed programming language. The base object 114 may include three methods. A base object attribute 402 of type object may hold the business object 116 which includes a name value 404 for the business object, a plurality of attributes 406, and a plurality of methods 408.

One method may implement the embedder 120 (FIG. 1), described above. The other two methods may comprise a generic accessor 410 also known as a getter and a generic modifier 412 also known as a setter. The accessor 410 provides a developer with access to all attributes 406 of the business object 116. Given a name of an attribute 406, the accessor 410 calls the proper business object specific getter 408. Similarly, with an attribute name 406, the modifier passes the call and any associated parameters to the proper setter 408.

For example, in one API, the accessor 410 is called using a “GetAttribute” command and passing the business object name value and a business object attribute name. Similarly, the modifier 412 may be called using a “SetAttribute” command and passing the business object name value, a business object attribute name, and a data value to be placed in the identified attribute. To obtain a data value, a developer may write, MyObj.GetAttribute (“Customer,” “Address”), where MyObj is of type base object. The accessor 410 receives the call and calls the GetAddress method 408 to retrieve the data value which the accessor 410 then passes as a return value to the code that called GetAttribute. To write a data value to an attribute, in one embodiment, a developer may write, MyObj.SetAttribute (“Customer,” “Address”). Similarly, the modifier 412 interacts with the proper setter 408 to insert the data value.

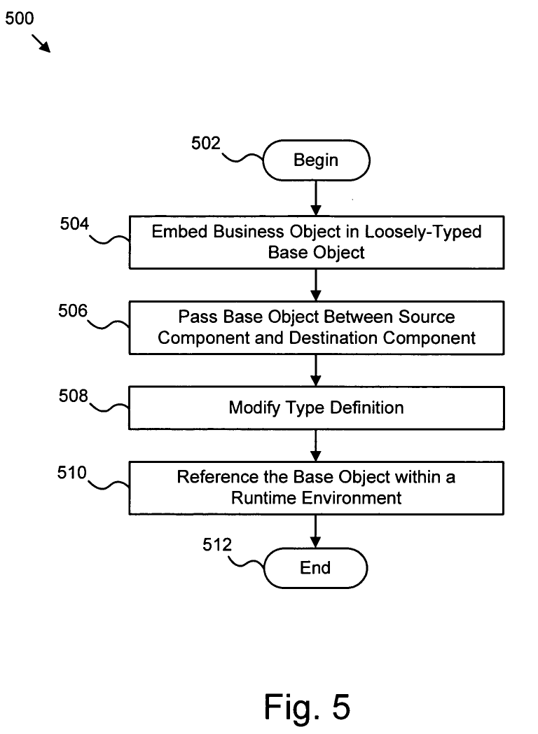

FIG. 5 illustrates a method 500 for facilitating dynamic modification of existing software objects defined in a strongly-typed programming language. In particular, the method 500 may operate within a runtime environment that supports dynamic loading of executable code such as for example Java. The method 500 may be embodied as a set of machine-readable instructions. The method 500 begins 502 when a source component or application 104 establishes a communication interface 108 with a destination component or application 106.

Initially, in one embodiment, an invocation framework 118a may create a loosely-typed base object 114 (unless one already exists) and pass the base object 114 a name value. The creation of the base object 114 may trigger the embedder 120 to access the type definition 122 associated with the name value to embed 504 a particular business object 116 within the base object 114. Next, the invocation framework 118a may pass 506 the base object 114 from the source component 104 to the destination component 106. The destination component 106 may access methods and attributes of the business object through indirect calls issued to the base object 114.

At some time during runtime, a developer or user may desire to dynamically modify a business object 116. Consequently, the developer may use the editor 128 or modification component 126 to modify 508 the type definition 122 of a particular business object 116. Alternatively, automated tools may modify 508 one or more type definitions 122. The modification changes the attribute structure of the business object 116 without affecting the typing requirements of the interface 108. The reference component 124 references 510 the base object 114 and not the business object 116. Consequently, the loose typing of the base object 114 remains unchanged after the modification.

In one embodiment, the modification component 126 may signal the invocation frameworks 118a-b to force embedders 120 in base objects 114 to reload the business object 116 using the modified type definition 122. Alternatively, the new type definitions 122 may be loaded naturally as new base objects 114 referencing the modified type definition 122 are created or reloaded. The type definitions 122 are uncompiled data such that executing code does not have to be reloaded or interrupted in order for the interface 108 to remain intact. In this manner, changes can be dynamically implemented for the structure and definitions of business objects 116 without interfering with interfaces 108 between components/applications 104, 106.

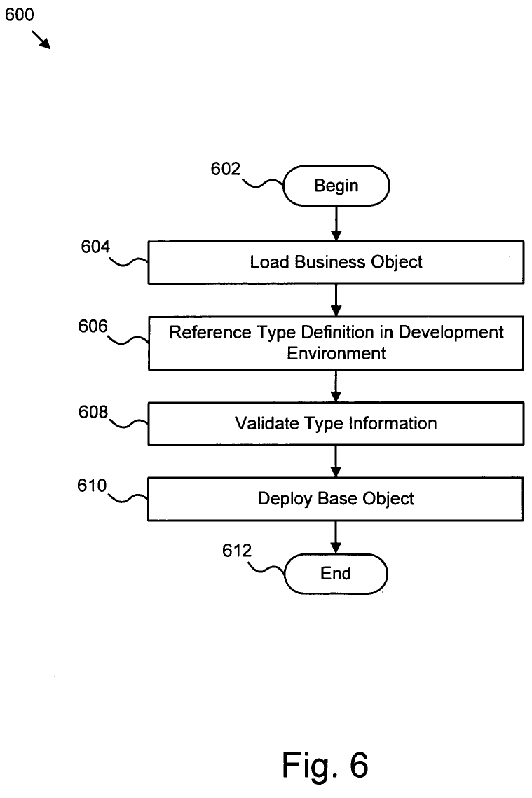

FIG. 6 illustrates a method 600 for facilitating dynamic modification of existing software objects defined in a strongly-typed programming language. In particular, the method 600 may operate within a development environment 202 that supports strong type checking during compile time. The method 600 may be embodied as a set of machine-readable instructions. The method 600 begins 502 when a developer declares or otherwise references a new base object 114.

In response to referencing a base object 114, the business object validator 214 may load 604 the business object 116 using the type definition 122 that corresponds to a name value provided with the base object reference. Preferably, the business object 116 is retained in memory of the IDE 202. The development reference component 210 may then reference 606 the type definition 122 repeatedly based on developer actions within a code editor 204 for example using a code assist component 212. Alternatively, the IDE 202 may reference an instance of the business object 116 retained by the IDE 202.

Next, as a developer relates typed data such as variables, method calls, or data values within the code editor 204, the validator 214 may dynamically validate 608 that data of the proper type is being provided based on type information within the type definition 122. Alternatively, the validator 214 may validate 608 predefined source code provided by the code compiler 206 as source code is compiled.

Next, a packager 216 may deploy the compiled source code. Preferably, the packager 216 deploys 610 executable code such as a class file for the base object 114 such that both the source component or application 104 and the destination component or application 106 will access the same base object executable code. Then, the method 600 ends 612.

Many of the functional units described in this specification have been labeled as components, in order to more particularly emphasize their implementation independence. For example, a component may be implemented as a hardware circuit comprising custom VLSI circuits or gate arrays, off-the-shelf semiconductors such as logic chips, transistors, or other discrete components. A component may also be implemented in programmable hardware devices such as field programmable gate arrays, programmable array logic, programmable logic devices or the like.

Components may also be implemented in software for execution by various types of processors. An identified component of executable code may, for instance, comprise one or more physical or logical blocks of computer instructions which may, for instance, be organized as an object, procedure, or function. Nevertheless, the executables of an identified component need not be physically located together, but may comprise disparate instructions stored in different locations which, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software components, user selections, network transactions, database queries, database structures, hardware components, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is: collaborating portions

118

a

-

b

that reside on both the source application

104

and the destination application

106

. The invocation frameworks

118

a

-

b

are configured to exchange the loosely-typed base object

114

. In one embodiment, the invocation frameworks

118

a

-

b

may comprise J2EE web services code libraries or objects configured to interpret WSDL messages and make the proper calls to objects on either the source application

104

or the destination application

106

.

1. An apparatus for facilitating dynamic modification of existing software objects defined in a strongly-typed programming language, the apparatus comprising:
an invocation framework configured to pass a loosely-typed base object between a source component and a destination component;
an embedder configured to embed a business object within the base object, the business object defined at least in part by an uncompiled type definition comprising a name value and a set of attributes, the name value serving as a unique identifier associating the type definition to the business object; and
a reference component configured to reference the base object in a runtime environment to verify typing requirements between the source component and the destination component such that typing requirements are not explicitly enforced for the business object.

2. The apparatus of claim 1, further comprising a development reference component configured to reference the type definition within a development environment such that typing for the business object is fixed during source code development and deployment.

3. The apparatus of claim 1, wherein the type definition defines an attribute structure for the business object, the apparatus further comprising a modification component configured to modify the type definition such that the attribute structure of the business object changes without affecting parameter typing requirements in force between the source component and the destination component.

4. The apparatus of claim 3, wherein the typing requirements are defined by the base object.

5. The apparatus of claim 1, wherein the invocation framework comprises a mediator configured to receive the base object from the source object, convert the base object to a strongly-typed base object, the strongly-typed base object satisfying typing requirements required by the destination component, and send the strongly-typed base object to the destination object.

6. The apparatus of claim 1, wherein the base object comprises a fixed-type object, the apparatus further comprising a mediator configured to convert fixed-type objects to strongly-typed objects and strongly-typed objects to fixed-type objects.

7. The apparatus of claim 1, further comprising an editor configured to define a loosely-typed parameter passing interface between the source component and the destination component that passes the base object in place of business objects, wherein the methods and attributes of the business objects are accessible to the source component and destination component by indirect software calls that reference the base object and the name value of a desired business object.

8. The apparatus of claim 7, wherein the loosely-typed parameter passing interface comprises a port type defined by a Web Services Description Language (WSDL) structure, the messages for operations defined for the port type comprising eXtensible Markup Language (XML) Schema Definitions (XSDs) that correspond to the type definitions.

9. The apparatus of claim 1, wherein the base object defines a generic accessor configured to read an attribute of a business object, the accessor accepting the name value and a business object attribute name and defines a corresponding generic modifier configured to modify the attribute of the business object, the modifier accepting the name value, the business object attribute name, and a business object attribute value.

10. The apparatus of claim 1, further comprising a validator configured to load a business object identified by the name value within the development environment in response to declaration of a new base object and compilation of source code comprising a new base object, validate type information for data values referenced in the source code against the type definition corresponding to the name value, and signal an error in response to a type mismatch.

11. The apparatus of claim 1, wherein the runtime environment comprises an application server configured to execute the source component and the destination component, the apparatus further comprising a packager configured to deploy executable code for the base object to an object definition repository accessible to both the source component and the destination component such that declarations to generate the base object in the source component and the destination component references the same base object executable code.

12. A system for facilitating dynamic modification of existing software objects defined in a strongly-typed programming language, the operations comprising:
an application server configured to execute a source application and a destination application, each application configured to pass a loosely-typed base object, the base object having a business object embedded therein;
an editor configured to define a plurality of type definitions representative of business objects configured to be embedded within the base object, each type definition comprising a name value and a set of attributes, the name value serving as a unique identifier associating the type definition to the business object, and each attribute having a data type; and
a reference component configured to reference the base object within a runtime environment such that typing requirements for the type definitions are insulated from examination as the base object is passed between the source application and the destination application.

13. The system of claim 12, further comprising a development reference component configured to reference the type definitions within a development environment such that typing for the business object is fixed during source code development and deployment.

14. The system of claim 12, wherein the type definitions define an attribute structure for business objects, the system further comprising a modification component configured to modify a type definition such that the attribute structure of a business object changes without affecting parameter typing requirements in force between the source component and the destination component.

15. The system of claim 12, further comprising a mediator configured to receive the base object from the source application, convert the base object to a strongly-typed base object in response to a type mismatch between the type of object sent by the source application and the type of object expected by the destination application, the strongly-typed base object matching the type of object expected by the destination application, and send the strongly-typed base object to the destination application.

16. The system of claim 12, wherein the editor is further configured to define a loosely-typed parameter passing interface between the source application and the destination application that passes the base object in place of business objects, wherein the methods and attributes of the business objects are accessible to the source application and destination application by indirect software calls that reference the base object and the name value of a desired business object.

17. The system of claim 16, wherein the loosely-typed parameter passing interface comprises a port type defined by a Web Services Description Language (WSDL) file, the messages for operations defined for the port type comprising extensible Markup Language (XML) Schema Definitions (XSDs) that correspond to the type definitions.

18. The system of claim 12, wherein the base object defines a generic accessor configured to read an attribute of a business object, the accessor accepting the name value and a business object attribute name and defines a corresponding generic modifier configured to modify the attribute of the business object, the modifier accepting the name value, the business object attribute name, and the business object attribute value.

19. The system of claim 12, further comprising a business object validator configured to load a business object identified by the name value within the development environment in response to declaration of a new base object and present a plurality of type definitions corresponding to business objects and further configured to present a plurality of attributes in response to referencing an attribute related method of the business object, the business validator invoked during compilation of source code comprising a new base object, the validator validating type information for data values referenced in the source code against the type definition corresponding to the name value.

20. The system of claim 12, further comprising a packager configured to deploy executable code for the base object to an object definition repository accessible to both the source application and the destination application such that declarations to generate the base object in the source application and the destination application references the same base object executable code.

21. A signal bearing medium tangibly embodying a program of machine-readable instructions executable by a digital processing apparatus to perform operations to facilitate dynamic modification of existing software objects defined in a strongly-typed programming language, the operations comprising:
an operation to pass a loosely-typed base object between a source component and a destination component;
an operation to embed a business object in the base object, the business object defined at least in part by a type definition comprising type information for attributes of the business object, the type definition comprising a name value and a set of attributes, the name value serving as a unique identifier associating the type definition to the business object, and each attribute having a data type; and
an operation to reference the base object within a runtime environment such that the type information for the business object is not explicitly enforced within the runtime environment.

22. The signal bearing medium of claim 21, further comprising an operation to reference the type definition within a development environment such that typing for the business object is fixed during source code development and deployment.

23. The signal bearing medium of claim 21, wherein the type definition defines an attribute structure for business objects, the operations further comprising an operation to modify the type definition such that the attribute structure of a business object changes without affecting parameter typing requirements in force between the source component and the destination component.

24. The signal bearing medium of claim 23, wherein the base object defines the parameter typing requirements.

25. The signal bearing medium of claim 21, wherein the operation to pass comprises, an operation to receive the base object from the source object;
an operation to convert the base object to a strongly-typed base object, the strongly-typed base object satisfying typing requirements in force between the source component and the destination component;
an operation to send the strongly-typed base object to the destination object.

26. The signal bearing medium of claim 21, further comprising an operation to define a loosely-typed parameter passing interface between the source component and the destination component that passes the base object in place of business objects, wherein the methods and attributes of the business objects are accessible to the source component and destination component by indirect software calls that reference the base object and the name value of a desired business object.

27. The signal bearing medium of claim 26, wherein the loosely-typed parameter passing interface comprises a port type defined by a Web Services Description Language (WSDL) file, the messages for operations defined for the port type comprising XML Schema Definitions (XSDs) that correspond to one or more type definitions.

28. The signal bearing medium of claim 21, wherein the base object defines a generic accessor configured to read an attribute of a business object, the accessor accepting the name value and a business object attribute name and defines a corresponding generic modifier configured to modify the attribute of the business object, the modifier accepting the name value, the business object attribute name, and the business object attribute value.

29. The signal bearing medium of claim 21, further comprising an operation to load a business object identified by the name value within the development environment in response to declaration of a new base object and compilation of source code comprising a new base object, the business object defined in part by the type definition, the operations comprising an operation to validate type information for data values referenced in the source code against the type definition corresponding to the name value, and an operation to signal an error in response to a type mismatch.

30. The signal bearing medium of claim 21, wherein the runtime environment comprises an application server configured to execute the source component and the destination component, the method further comprising an operation to deploy executable code for the base object to an object definition repository accessible to both the source component and the destination component such that declarations to generate the base object in the source component and the destination component reference the same base object executable code.
